(19) United States
(12) Patent Application Publication
(10) Pub. No.: US 2005/0035937 A1
(43) Pub. Date: Feb. 17, 2005

(54) Electro-optical device, substrate for electro-optical device, electronic apparatus, and method of manufacturing electro-optical device

(76) Inventor: Reiko Wachi, Matsumoto-city (JP)

Correspondence Address: HARNESS, DICKEY & PIERCE, P.L.C., P.O. BOX 828, BLOOMFIELD HILLS, MI, 48303, US

(21) Appl. No.: 10/899,297

(22) Filed: Jul. 26, 2004

(30) Foreign Application Priority Data
Jul. 29, 2003 (JP) 2003-281910
Apr. 16, 2004 (JP) 2004-121481

(51) Int. Cl. G09G 3/36

(52) U.S. Cl. 345/88

(57) ABSTRACT

An electro-optical device is provided. In the electro-optical device, metal reflecting films corresponding to a reflective region are formed on a transparent substrate and an insulating layer is formed so as to surround each of the reflecting films, made of a metal such as aluminum, around the metal reflecting films. A color filter layer is formed so as to cover the reflecting films. Therefore, in each pixel region, the reflecting film is provided in the insulating layer in an island shape so as to be separated from adjacent reflecting films.

### RELATED APPLICATIONS

This application claims priority to Japanese Patent Application Nos. 2003-281910 filed Jul. 29, 2003 and 2004-121481 filed Apr. 16, 2004 which are hereby expressly incorporated by reference herein in their entirety.

### BACKGROUND OF THE INVENTION

1. Field of Invention

The present invention relates to an electro-optical device such as a liquid crystal device and an electronic apparatus. In addition, the present invention relates to an electrophoresis device such as electronic paper and to an electroluminescent (EL) device.

2. Description of Related Art

In the conventional art, transflective liquid crystal display panels capable of implementing reflective display using external light and transmissive display using illumination light, such as a backlight, have been disclosed. Transflective liquid crystal display panels include a reflecting layer for reflecting the external light thereat so that the illumination light from the backlight can pass through the reflecting layer. Such a reflecting layer includes an aperture of a predetermined ratio in each of the pixels of the liquid crystal display panel.

In general, in transflective color liquid crystal display panels, a color filter and a metal reflecting film are provided on one side of each of a pair of transparent substrates and a liquid crystal layer is interposed therebetween. The external light passes through the liquid crystal layer and the color filter layer, is reflected by the reflecting films, passes through the color filter and the liquid crystal layer again, and reaches an observer. As a result, reflective display is performed.

Transparent electrodes arranged in the row or column directions of the liquid crystal display panel are provided on the color filter layer. On the other hand, the reflecting films that constitute a reflection region are generally made of a metal such as aluminum. Therefore, when pinholes or a conductive foreign substance exist in the color filter layer between the transparent electrodes and the metal reflecting films, the transparent electrodes are electrically connected to the metal reflecting films. In addition, when a high voltage is applied to a pigment resist that constitutes the color filter layer, the pigment resist exhibits dielectric breakdown so that the transparent electrodes are electrically connected to the metal reflecting films.

In general, the metal reflecting films are continuously formed between a plurality of pixel regions so that the apertures for the transmissive display are provided around the centers of the respective pixel regions. Therefore, when the transparent electrode is electrically connected to the metal reflecting film in a certain one pixel region, as mentioned above, the voltage level of all of the pixels arranged in one direction of the transparent electrodes, that is, in the row or column direction, is lowered so that linear or planar display defects (that is, linear defects or planar defects) are generated in the liquid crystal panel.

Furthermore, in order to prevent such problems from occurring in the reflective liquid crystal display panel, the metal reflecting films are formed in the same pattern as the transparent electrodes so that the adjacent metal reflecting films are isolated from each other to thus prevent the metal reflecting films from being electrically connected to the transparent electrodes.

### SUMMARY

Accordingly, it is an object of the present invention to provide a transflective electro-optical panel capable of preventing linear defects or planar defects from being generated even when a transparent electrode is electrically connected to a metal reflecting film in a certain pixel region.

According to an aspect of the present invention, there is provided an electro-optical device, comprising a reflective region and a transmissive region provided in each pixel region, a plurality of reflecting films constituting the reflective region, the plurality of reflecting films being provided on a transparent substrate so as to correspond to the pixel regions, an insulating layer provided so as to surround each of the reflecting films, an insulating color filter layer provided in the reflective region and the transmissive region, and further formed on the reflecting films, and electrodes formed on the color filter layer.

According to the above-mentioned aspect of the present invention, there is provided a method of manufacturing an electro-optical device having a reflective region and a transmissive region formed in each pixel region. The method comprises the steps of providing a plurality of reflecting films which constitute the reflective region on a transparent substrate so as to correspond to all of the pixel regions, forming an insulating layer on the transparent substrate so as to surround each of the reflecting films, forming a color filter layer on the reflecting films, and forming electrodes on the color filter layer.

The electro-optical device is a substrate that constitutes an electro-optical panel such as a liquid crystal display panel and is composed of a transparent substrate such as glass. To be specific, the metal reflecting films that correspond to the reflective region are formed on the transparent substrate and insulating layers are formed around the metal reflecting films so as to surround the reflecting films made of a metal such as aluminum. In addition, a color filter layer is formed so as to cover the reflecting films. Therefore, in each of the pixel regions, the reflecting film is formed in an island shape in the insulating layer to thus be isolated from adjacent reflecting films. As a result, even when defects such as pinholes exist in the color filter layer or conductive foreign substances such as the metal are attached to the color filter layer so that the reflecting films are electrically connected to the transparent electrodes, it is possible to prevent the other pixel regions other than the corresponding pixel region from being affected. That is, when an electrode is electrically connected to a reflecting film in a certain pixel region, it is possible to prevent current from leaking in a direction perpendicular to the longitudinal direction of the electrode and to thus reduce the generation of defects. Therefore, it is possible to prevent linear defects or planar defects from being generated and to thus improve the yield of the electro-optical panel.

The insulating layer may correspond to the transmissive region of the color filter layer. That is, the color filter layer can be provided between the adjacent reflecting films as the insulating layer. Instead of the color filter layer, an insulating resin layer can be provided between the reflecting films.

Further, the reflecting films are island-shaped reflecting films formed in the respective columns and rows of the pixels, island-shaped reflecting films formed in each color pixel that is a set of the respective pixels of the R, G, and B color filters, or island-shaped reflecting films formed in the respective pixels. Therefore, in a certain pixel region, when the foreign substance is attached between the transparent electrode and the reflecting film, it is possible to divide the area in which defects are generated due to the presence of the foreign substances into a transmissive region and a reflective region.

The electro-optical device includes a transparent substrate and scattering layers provided on the transparent substrate. The scattering layers can be provided in the regions corresponding to the reflecting films. Further, the electro-optical device may include the electrodes provided on the color filter layer.

It is possible to constitute an electronic apparatus including the electro-optical device as a display unit.

### BRIEF DESCRIPTION OF THE DRAWINGS

FIGS. 1(a)-(b) illustrate the structure of a color filter substrate according to a first embodiment of the present invention.

FIGS. 2(a)-(b) illustrate the structure of a color filter substrate according to a comparative example.

FIGS. 3(a)-(b) illustrate the structure of a color filter substrate according to a second embodiment of the present invention.

FIGS. 4(a)-(b) illustrate a color filter substrate to which foreign substances are attached.

FIGS. 5(a)-(c) illustrate a modification of the color filter substrate according to the second embodiment.

FIG. 6 illustrates another modification of the color filter substrate according to the second embodiment.

FIGS. 7(a)-(b) illustrate the structure of a color filter substrate according to a third embodiment.

FIG. 8 illustrates the structure of a liquid crystal display panel according to the present invention.

FIG. 9 illustrates a method of manufacturing the liquid crystal display panel.

FIGS. 10(a)-(b) illustrate an example of an electronic apparatus according to the present invention.

### DETAILED DESCRIPTION

Hereinafter, preferred embodiments of the present invention will be described with reference to the accompanying drawings. Furthermore, a liquid crystal display panel will now be described as an example of an electro-optical panel according to the present invention.

Color Filter Substrate

First, a color filter substrate of a liquid crystal display panel according to the present invention will now be described. Furthermore, the color filter substrate refers to a side substrate, on which color filters are provided, between a pair of transparent substrates between which a liquid crystal layer is interposed.

First Embodiment

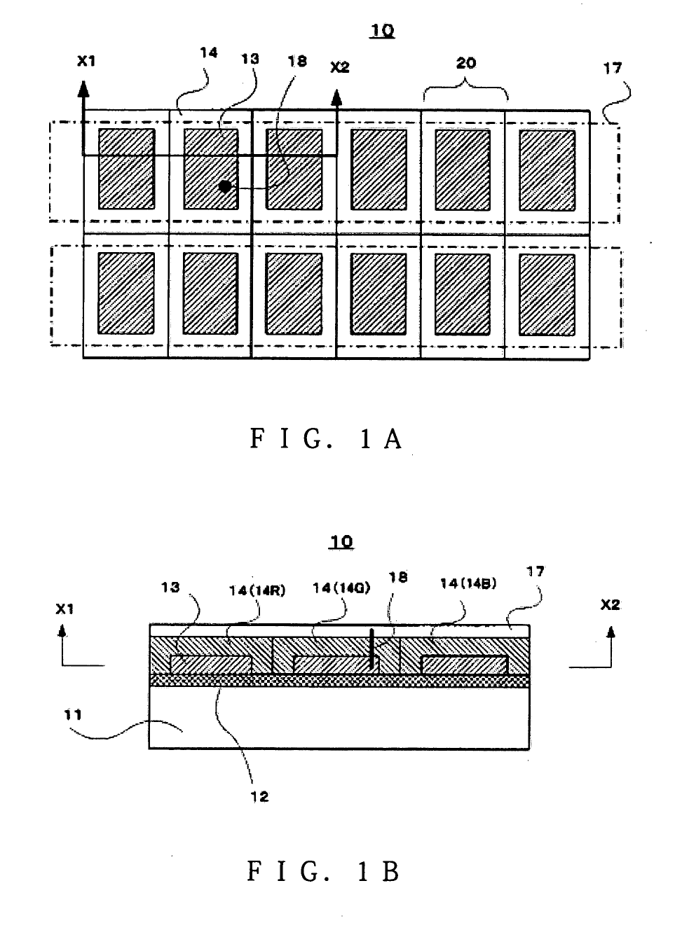

FIG. 1(a) is a plan view illustrating a part of a color filter substrate according to a first embodiment of the present invention. FIG. 1(b) is a sectional view taken along the line X1-X2 of FIG. 1(a). As illustrated in the drawings, a color filter substrate 10 is obtained by sequentially laminating, on a transparent substrate 11 such as glass, a resin scattering layer 12, metal reflecting films 13, an insulating color filter layer 14, and transparent electrodes 17, from the transparent substrate 11 side. In addition, one pixel region is denoted by reference numeral 20. Furthermore, in the case of a color liquid crystal display panel, one color pixel is formed of a set of respective RGB pixels. According to the present specification, each pixel of each color is referred to as a pixel regardless of the color and a set of the respective RGB pixels is referred to as a color pixel so as to distinguish the former from the latter.

The resin scattering layer 12 is made of resin such as epoxy and acryl and has a minute concavo-convex portion formed thereon. The resin scattering layer 12 is provided on the other sides (that is, the surfaces opposite to the surfaces that reflect external light) of the metal reflecting films 13 so as to scatter the light reflected by the metal reflecting films 13.

The metal reflecting films 13 are formed of, for example, an aluminum alloy and a silver alloy on the resin scattering layer 12. As illustrated, the metal reflecting films 13 are not formed on all of the pixel regions 20 but are formed in an island shape near the centers of the pixel regions 20. That is, the metal reflecting films 13 in the respective pixel regions 20 are separated from the metal reflecting films 13 in the adjacent pixel regions 20, that is, the adjacent metal reflecting films 13. In each pixel region 20, the region in which the metal reflecting film 13 is formed is a reflective region and the other region is a transmissive region.

The color filter layer 14 is formed on the metal reflecting films 13. FIG. 1(b) illustrates the pixel regions 20 of the RGB colors that constitute one color pixel. For example, the color filter layer 14 is composed of a red color filter 14R, a green color filer 14G, and a blue color filter 14B from the left.

The transparent electrodes 17, made of indium-tin oxide (ITO), are formed on the color filter layer 14. In FIG. 1, the transparent electrodes 17 are formed in the horizontal direction of the drawing; however, they may be formed in the vertical direction. Further, a resin protecting film may be provided between the color filter layer 14 and the transparent electrodes 17.

As mentioned above, according to the color filter substrate 10 of the present invention, in the respective pixel regions 20, the metal reflecting films 13 are formed in an island shape near the centers of the pixel regions 20 and are surrounded by the color filter layer 14 serving as an insulating layer. That is, the respective metal reflecting films 13 are electrically insulated by the insulating layer interposed therebetween. Therefore, when the transparent electrode 17 is electrically connected to the metal reflecting film 13 in one pixel region 20 due to the above-mentioned factors, only the corresponding pixel region 20 is affected so that it is possible to prevent the adjacent pixel regions 20 from being affected, for example, leakage current being generated in the adjacent pixel regions 20.

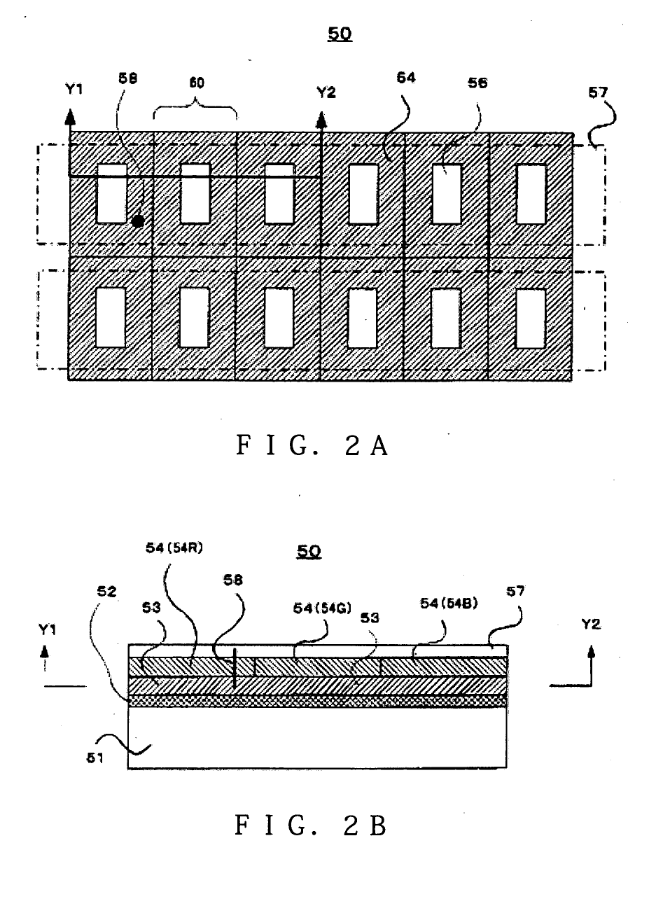

This will be described in more detail with reference to FIG. 2. FIG. 2 illustrates an example of a color filter substrate in which the metal reflecting films are continuously provided in the adjacent pixel regions so that apertures that define the transmissive region are provided near the centers of the respective pixel regions. FIG. 2(a) is a plan view of a part of a color filter 50. FIG. 2(b) is a sectional view taken along the line Y1-Y2 in FIG. 2(a). As illustrated in FIG. 2(b), a resin scattering layer 52 is formed on a transparent substrate 51 and metal reflecting films 53 are formed on the resin scattering layer 52. As illustrated in FIG. 2(a), apertures 56 are provided in the metal reflecting films 53. A color filter layer 54 is formed on the metal reflecting films 53 and transparent electrodes 57 are provided on the color filter layer 54.

In FIGS. 2(a) and 2(b), it is assumed that the transparent electrode 57 is electrically connected to the metal reflecting films 53 through a conductive portion 58 due to certain factors. Furthermore, the reference numeral 58 schematically denotes such a conductive portion and does not denote the shape of a foreign substance. As mentioned above, when electrical conduction occurs in a part of a certain pixel region 60, as illustrated in FIG. 2(a), the transparent electrode 57 corresponding to the pixel region 60 is electrically connected to the metal reflecting films 53 continuously formed over the entire display region of the color filter substrate 50. As a result, in the example of FIG. 2(a), current leaks in the transparent electrode 57 (the upper transparent electrode 57) corresponding to the pixel region including the conductive portion 58 and the entire metal reflecting film 53 so that linear defects or planar defects are generated over one entire column corresponding to the transparent electrode 57 or a plurality of columns. Therefore, when the transparent electrode 57 is electrically connected to the metal reflecting film 53 due to the foreign substances and other factors only in one pixel region 60, linear defects or planar defects including the pixel are generated.

A conductive portion 18 is illustrated in FIGS. 1(a) and 1(b). In the case of the color filter substrate 10 according to the first embodiment of the present invention, as mentioned above, the metal reflecting films 13 are independently formed in the respective pixel regions 20 and are separated from the metal reflecting films 13 in the adjacent pixel regions 20. Therefore, even if the conductive portion 18 is generated in one arbitrary pixel region 20, current leaks only in the pixel region and between the pixel region and the transparent electrode 17, and the value of the leakage current is small. Therefore, with respect to the liquid crystal display panel, defects in display may be generated only in the corresponding pixel region and no linear defects or planar defects are generated.

As mentioned above, according to the first embodiment, the metal reflecting films 13 are formed in the respective pixel regions in an island shape and are surrounded by an insulating layer, such as a color filter layer. Therefore, even if electrical conduction occurs in one pixel region, it is possible to prevent the linear defects or the planar defects leading to defects in the entire liquid crystal display panel and to thus improve the yield of the liquid crystal display panel.

In the example of FIG. 1, the insulating color filter layer surrounds the metal reflecting films 13. However, after an insulating layer is formed of transparent resin, the color filter layer may be formed on the insulating layer.

Second Embodiment

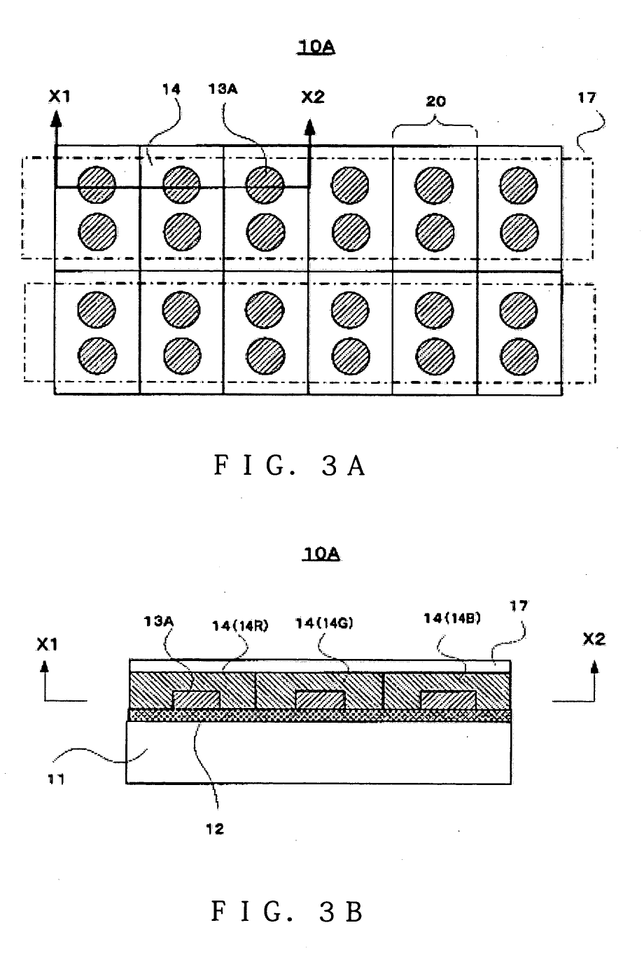

Next, a second embodiment will be described. FIG. 3 illustrates the structure of a color filter substrate 10A according to the second embodiment of the present invention. FIG. 3(a) is a plan view of a part of the color filter substrate 10A. FIG. 3(b) is a sectional view taken along the line X1-X2. In the second embodiment, like in the first embodiment, metal reflecting films are formed in the respective pixel regions 20 in an island shape and are surrounded by an insulating layer. However, according to the second embodiment, as illustrated in FIG. 3(a), a plurality of metal reflecting films 13A are formed in one pixel region 20. The second embodiment is the same as the first embodiment except that the plurality of metal reflecting films 13A are formed in the respective pixel regions 20. Therefore, as noted by comparing FIG. 1(b) with FIG. 3(b), the laminated structure of the cross-section of the color filter substrate 10A is the same as the laminated structure of the cross-section of the color filter substrate 10 excluding the width of the metal reflecting film 13A.

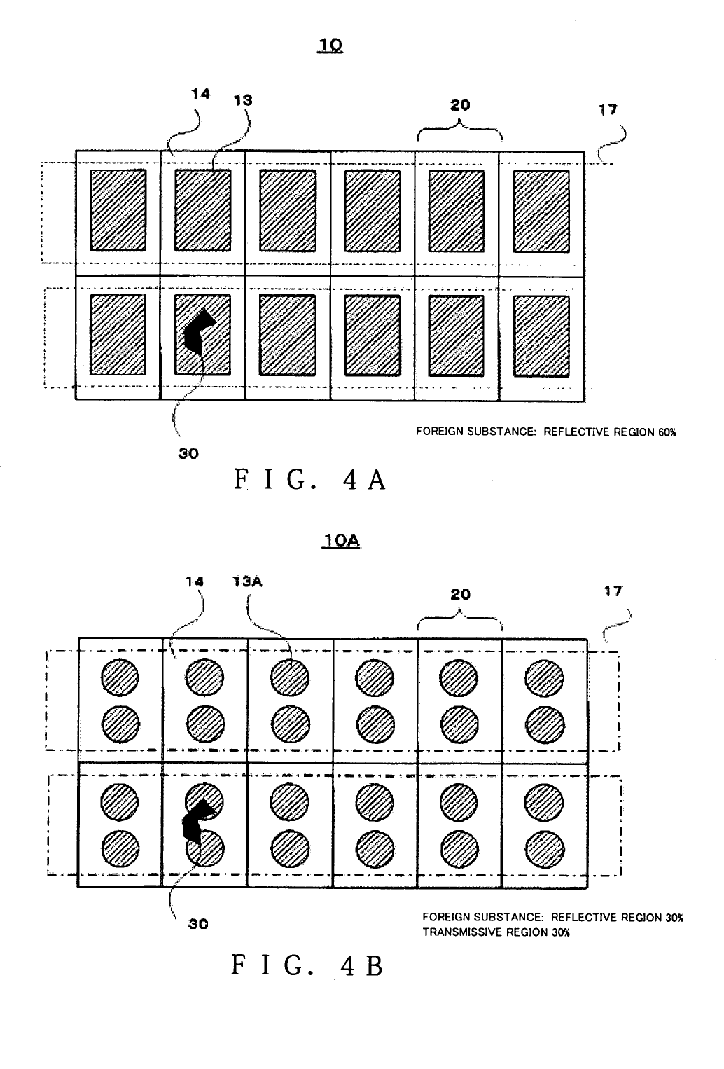

As mentioned above, it is possible to reduce the influence due to the foreign substances attached between the transparent electrodes 17 and the metal reflecting films 13A by arranging the plurality of metal reflecting films 13A in the respective pixel regions 20. This will be described with reference to FIG. 4. FIG. 4(a) is a plan view of a part of the color filter substrate 10 according to the first embodiment. FIG. 4(b) is a plan view of the color filter substrate 10A according to the second embodiment. Herein, as illustrated, in consideration of the case where the foreign substance 30 is attached between the transparent electrode 17 and the metal reflecting films 13A, the area of the metal reflecting films covered with the foreign substance 30 is smaller in the case of FIG. 4(b) than in the case of FIG. 4(a). That is, according to the second embodiment illustrated in FIG. 4(b), when the same foreign substance 30 is attached, the defective area generated by the presence of the foreign substance 30 can be divided into the region of the metal reflecting film 13A and the other region, that is, a reflective region and a transmissive region. For example, when it is assumed that a color filter substrate is determined to be defective when the defective area is larger than 50% in the reflective region and the transmissive region, in the example of FIG. 4(a), the defective area of the reflective region caused by the foreign substance is 60%. Therefore, the color filter substrate 10 is determined to be defective. On the other hand, in the example of FIG. 4(b), since the defective area is 30% in both the reflective region and the transmissive region, the color filter substrate 10A is determined to be good. In addition, when the metal reflecting film is divided into the plurality of metal reflecting films, it is possible to disperse the leakage current generated between the transparent electrodes 17 and the metal reflecting films 13A and to thus disperse the influence by driving the pixels.

As mentioned above, according to the second embodiment, since the metal reflecting film formed in each of the pixel regions is divided into the plurality of metal reflecting films, it is possible to reduce the influence of the attached foreign substance.

In FIG. 3(b), the resin scattering layer 12 is continuously formed on the transparent substrate 11. However, the resin scattering layers 12 may have the same pattern as the metal reflecting films 13A and thus are formed only under the metal reflecting films 13A. In addition, the color filter layer 14 formed on the metal reflecting films 13A may be uniformly formed in each pixel region 20 and may be formed with different densities and transmittance ratios in the reflective region in which the metal reflecting films 13A are formed and the transmissive region other than the reflective region. The color filter layer 14 corresponding to the transmissive region may be achromatic.

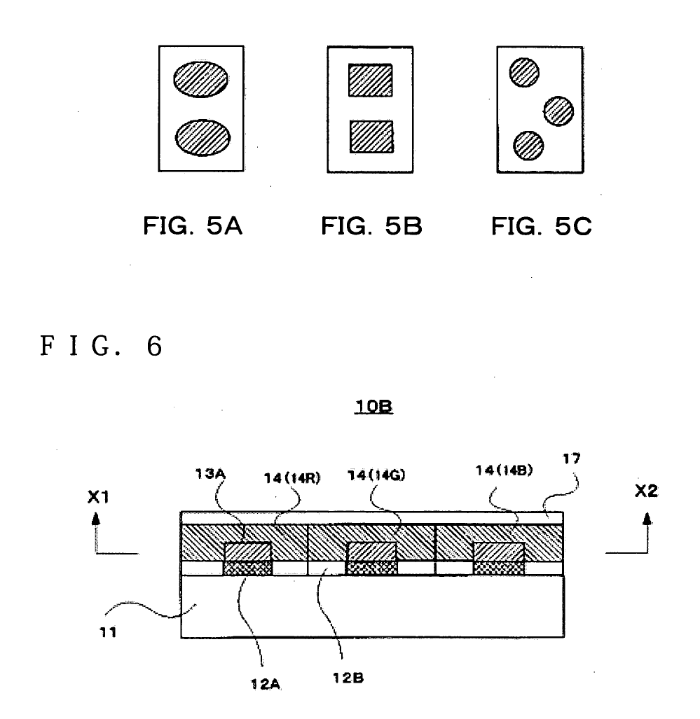

In the example of FIG. 3, the metal reflecting films 13A are circular, but may have any shape as long as they are planar. For example, as illustrated in FIGS. 5(a) and 5(b), the metal reflecting films 13A may have elliptical or rectangular plane shapes. In addition, the number of metal reflecting films 13A formed in one pixel region 20 is not limited to two, as illustrated in FIG. 3, but may be three, as illustrated in FIG. 5(c), or more than three. Also, according to the present embodiment, a plurality of the metal reflecting films 13A exists. However, the reflectance ratio of the reflective region is defined by the total area of the plurality of metal reflecting films 13A. Therefore, for example, when the color filter 10A having the same reflectance ratio as the reflectance ratio of the color filter 10 according to the first embodiment illustrated in FIG. 1 is manufactured, the total area of the plurality of metal reflecting films 13A is preferably the same as the area of the one metal reflecting film 13 illustrated in FIG. 1.

Furthermore, in the example of FIG. 3, the metal reflecting films 13A are surrounded by the insulating color filter layer. However, as illustrated in FIG. 6, after an insulating layer is formed of transparent resin 12B, the color filter layer may be formed on the insulating layer. The resin scattering layers 12 are in the same pattern as the metal reflecting films 13A and are formed only under the metal reflecting films 13A.

Third Embodiment

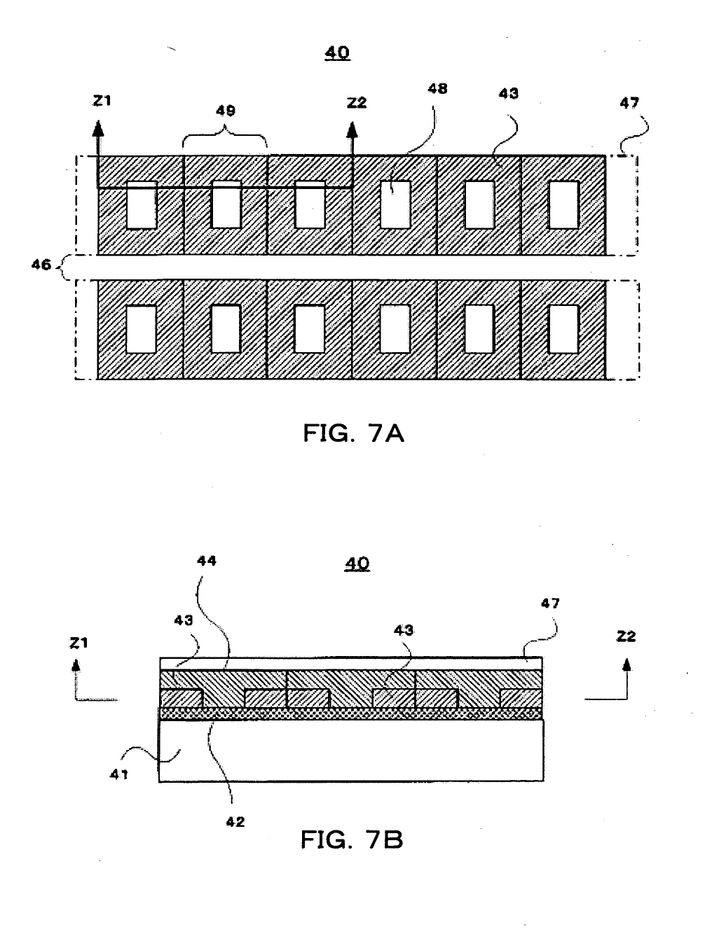

Next, a third embodiment of the present invention will now be described. FIG. 7(a) is a plan view of a part of a color filter substrate 40 according to the third embodiment. FIG. 7(b) is a sectional view taken along the line Z1-Z2 of FIG. 7(a).

In the present embodiment, unlike in the first and second embodiments, metal reflecting films 43 are formed in external regions in the respective pixel regions 49 and apertures 48 are formed in the centers of the respective pixel regions 49. The region in which the metal reflecting films 43 are formed is a reflective region. The region in which the apertures 48 are formed is a transmissive region. In the laminated structure of the cross-section, as illustrated in FIG. 7(b), a resin scattering layer 42, metal reflecting films 43, a color filter layer 44, and transparent electrodes 47 are sequentially formed on a transparent substrate 41. Herein, as illustrated in FIG. 7(a), the metal reflecting films 43 are continuously formed among the pixel regions 49 adjacent to each other in the longitudinal direction of the transparent electrodes; however, they are discontinuously formed between the pixel regions 49 adjacent to each other in the direction perpendicular to the longitudinal direction of the transparent electrodes so as to be separated from each other by a gap 46.

As mentioned above, even when an omission portion 46 of the metal reflecting films 43 is formed along the longitudinal direction of the transparent electrodes 47 so that the transparent electrode 47 is electrically connected to the metal reflecting film 43 in one arbitrary pixel region 49, the leakage of current caused by the electrical conduction occurs only in the corresponding transparent electrode 47. Furthermore, since the apertures 48 are formed in the centers of the metal reflecting films 43, the amount of the leakage current is reduced compared with the case in which the apertures 48 do not exist. Therefore, compared with the example illustrated in FIG. 2, it is possible to reduce the possibility of generating the plurality of linear defects or planar defects due to the electrical conduction that occurs in one pixel region.

According to another embodiment, the metal reflecting film may be formed in an island shape in each color pixel that is a set of respective RGB pixels. That is, a metal light shielding film may be electrically insulated from each color pixel by an insulating resin, such as a color filter layer.

Liquid Crystal Display Panel

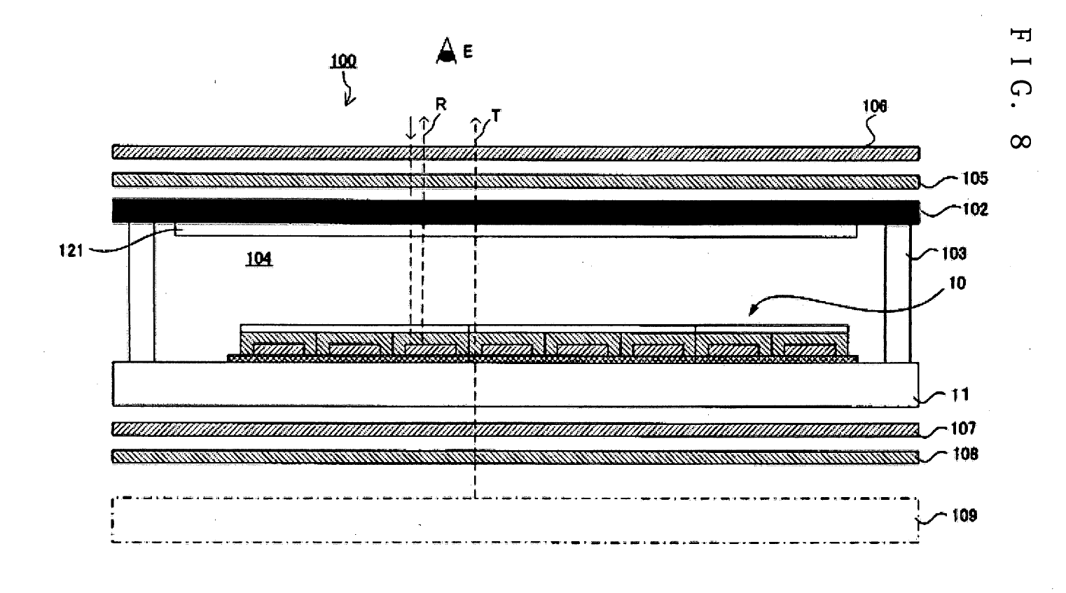

Next, an embodiment of a liquid crystal display panel to which a color filter substrate according to the present invention is applied will now be described. According to the embodiment, the color filter substrate illustrated in FIG. 1 is applied to a transflective liquid crystal display panel. FIG. 8 is a sectional view illustrating the transflective liquid crystal display panel. In addition, in FIG. 8, the same components as the components in the color filter substrate 10 illustrated in FIG. 1 are denoted by the same reference numerals.

In FIG. 8, a liquid crystal display panel 100 is formed by attaching a substrate 11 made of glass or plastic to a substrate 102 with a sealing material 103 interposed therebetween and by sealing liquid crystal 104 between the substrate 11 and the substrate 102. In addition, a phase difference plate 105 and a polarizer 106 are sequentially arranged on the external surface of the substrate 102. A phase difference plate 107 and a polarizer 108 are sequentially arranged on the external surface of the substrate 11. Also, a backlight 109 that emits illumination light when transmissive display is performed is arranged below the polarizer 108.

The substrate 11 constitutes the color filter substrate 10 described with reference to FIG. 1. In more detail, the transparent resin scattering layer 12 made of acryl resin is formed on the substrate 11. The metal films 13 are formed on the resin scattering layer 12 in the reflective region. In the reflective region, the respective color filters 14R, 14G, and 14B are formed on the metal reflecting films 13.

Black matrices are formed on the boundaries of the respective color filters 14R, 14G, and 14B; however, these are not shown. In addition, the black matrices may be formed by overlapping the color filters of the three RGB colors and may be formed of resin different from the color filters of the three RGB colors.

In addition, transparent electrodes 17 made of a transparent conductor, such as indium-tin oxide (ITO), are formed on the color filter layer 14. According to the present embodiment, the transparent electrodes 17 are formed in stripes to be parallel to each other. Also, the transparent electrodes 17 extend in the direction orthogonal to transparent electrodes 121 formed on the substrate 102 in stripes. The members that constitute the liquid crystal display panel 100 and that are included in the intersections between the transparent electrodes 17 and the transparent electrodes 121 constitute pixel regions 20.

Further, a protecting layer (not shown) may be formed to cover the color filter layer 14. The protecting layer is provided so as to prevent the color filter layer from being eroded or contaminated by chemicals during the processes of manufacturing the liquid crystal display panel.

On the other hand, transparent electrodes 121 are formed on the internal surface of the substrate 102 so as to intersect the transparent electrodes 17 on the counter substrate 11. Further, alignment films are formed on the transparent electrodes 17 on the substrate 11 and on the transparent electrodes 121 on the substrate 102 if necessary.

In the liquid crystal display panel 100, when the reflective display is performed, external light incident on the region where the metal reflecting films 13 are formed travels along the path R illustrated in FIG. 8 and is reflected by the metal reflecting films 13 so that an observer can view the external light. On the other hand, when the transmissive display is performed, the illumination light emitted from the backlight 109 is incident on the transmissive region and travels along the path T as illustrated in FIG. 8 so that the observer can view the illumination light.

Further, the color filter substrate 10 according to the first embodiment is applied to the liquid crystal display panel 100; however, the color filter substrate according to the second and third embodiments can be applied.

Manufacturing Method

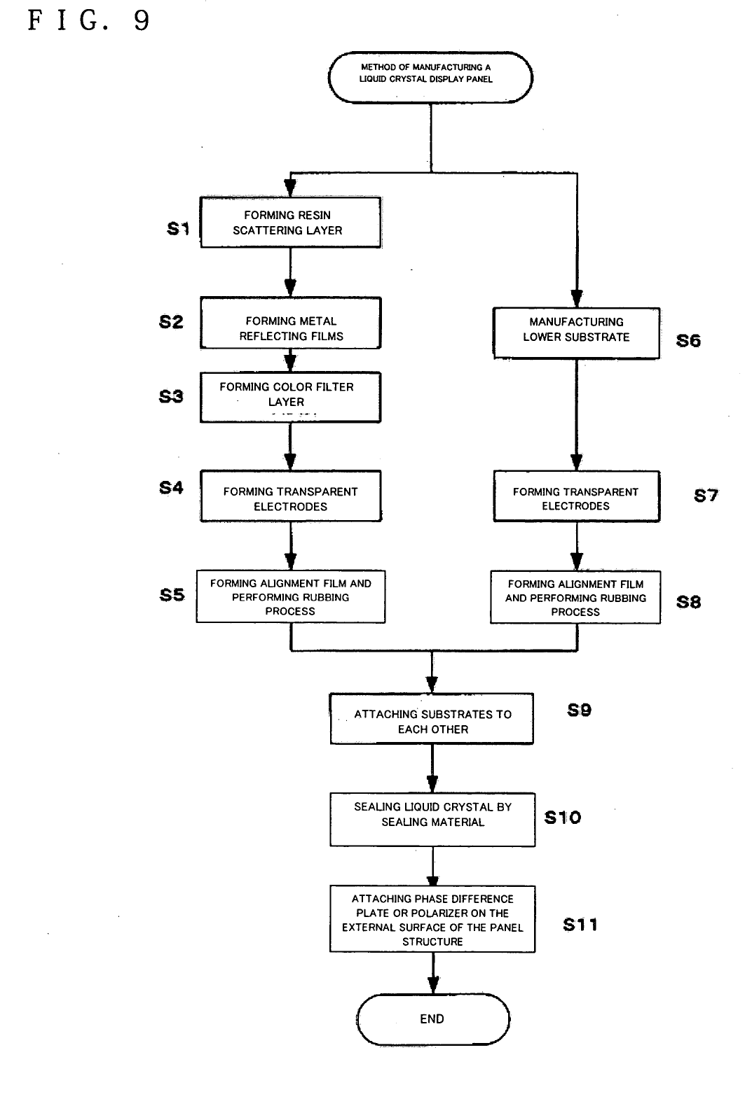

Next, a method of manufacturing the above-mentioned liquid crystal display panel 100 will now be described. FIG. 9 illustrates a method of manufacturing the liquid crystal display panel.

First, the resin scattering layer 12 is formed on the surface of the substrate 11 (step S1). According to the method of forming the resin scattering layer 12, after forming a resist layer of a predetermined film thickness by spin coating, the resist layer is pre-baked. Then, exposure and development are performed after arranging a photomask in which a predetermined pattern is formed so that a minute concavo-convex portion is formed on the surface of the glass substrate. Furthermore, heat treatment is performed on the concavo-convex portion formed on the glass substrate as mentioned above so that the concavo-convex portion is transformed by heating to thus obtain a smooth concavo-convex portion. In addition, methods other than the above-mentioned method can be adopted as the method of forming the resin scattering layer 12.

Next, a metal such as aluminum, an aluminum alloy, and a silver alloy is formed in a thin film by a deposition method or a sputtering method and the thin film is patterned using a photolithography method to thus form the metal reflecting films 13 (step S2). At this time, the metal reflecting films 13 are formed only in the reflective region. Next, the metal reflecting films 13 are coated with colored photosensitive resin (a photosensitive resist) formed by dispersing a pigment or a dye having a predetermined color and are patterned by performing exposure and development with a predetermined pattern to thus form the color filter layer 14 (step S3).

Next, a transparent conductor is coated by the sputtering method and patterned by the photolithography method to thus form the transparent electrodes 17 (step S4). Then, an alignment film made of polyimide resin is formed on the transparent electrodes 17 and a rubbing process is performed on the alignment film (step S5).

The opposite substrate 102 is then manufactured (step S6). The transparent electrodes 121 are formed by the same method (step S7). The alignment film is formed on the transparent electrodes 121 and the rubbing process is performed on the alignment film (step S8).

A panel structure is formed by attaching the substrate 11 and the substrate 102 to each other with the sealing material 103 interposed therebetween (step S9). The substrate 11 and the substrate 102 are attached to each other such that the substrate 11 and the substrate 102 are separated from each other by spacers (not shown), scattered between the substrates, by the roughly defined substrate spacing. Then, the liquid crystal 104 is injected from an aperture (not shown) in the sealing material 103 and the aperture in the sealing material 103 is sealed by a sealing material, such as UV-hardening resin (step S10). After completing the main panel structure as mentioned above, the above-mentioned phase difference plate and polarizer are attached on the external surface of the panel structure by an adhesion method if necessary (step S11) to thus complete the liquid crystal display panel 100 illustrated in FIG. 8.

Although the method of manufacturing the liquid crystal display panel to which the color filter substrate according to the first embodiment is applied has been described, liquid crystal panels to which the color filter substrates according to the second and third embodiments are applied can be manufactured by the same method.

Electronic Apparatus

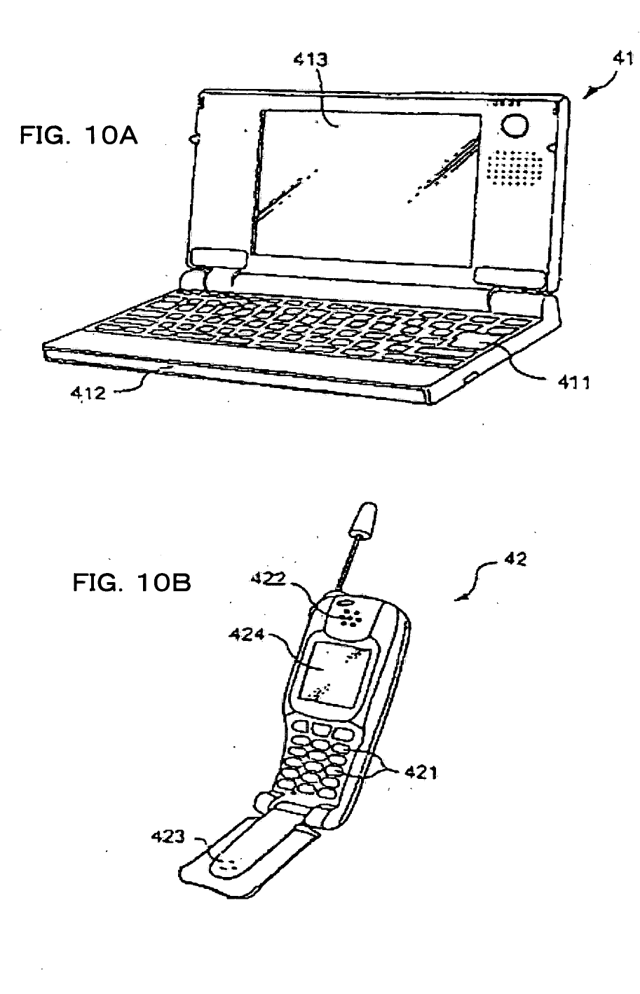

An example of an electronic apparatus to which the liquid crystal display panel according to the present invention can be applied will now be described with reference to FIG. 10.

First, an example of applying the liquid crystal display panel according to the present invention to a display unit of a portable personal computer (a so-called notebook personal computer) will be described. FIG. 10(a) is a perspective view illustrating the structure of the personal computer. As illustrated in FIG. 10(a), a personal computer 41 includes a main body 412 including a keyboard 411 and a display unit 413 to which the liquid crystal display panel according to the present invention is applied.

Subsequently, an example of applying the liquid crystal display panel according to the present invention to a display unit of a mobile phone will be described. FIG. 10(b) is a perspective view illustrating the structure of the mobile phone. As illustrated in FIG. 10(b), a mobile phone 42 includes a plurality of operating buttons 421, an earpiece 422, a mouthpiece 423, and a display unit 424 to which the liquid crystal display panel according to the present invention is applied.

In addition, the electronic apparatuses to which the liquid crystal display panels according to the present invention can be applied include a liquid crystal TV, a view finder type and monitor direct-view-type video camera, a car navigation device, a pager, an electronic organizer, a calculator, a word processor, a work station, a video phone, a POS terminal, and a digital still camera, as well as the personal computer illustrated in FIG. 10(a) and the mobile telephone illustrated in FIG. 10(b).

Modifications

The substrate and the liquid crystal device having the above-mentioned reflecting layer and color filters are not limited to the above-mentioned embodiments and various changes may be made without departing from the spirit and scope of the present invention.

According to the above-mentioned embodiments, a passive-matrix liquid crystal display panel is described. However, the electro-optical device according to the present invention can also be applied to an active-matrix liquid crystal display panel (for example, a liquid crystal display panel including a thin film transistor (TFT) or a thin film diode (TFD) as a switching element) and an electron emission element (such as a field emission display and a surface-conduction electron-emitter display).

1. An electro-optical device, comprising:
a reflective region and a transmissive region provided in each pixel region;
a plurality of reflecting films constituting the reflective region, the plurality of reflecting films being provided on a transparent substrate so as to correspond to the pixel regions;
an insulating layer provided so as to surround each of the reflecting films;
an insulating color filter layer provided in the reflective region and the transmissive region, and further formed on the reflecting films; and
electrodes formed on the color filter layer.

2. The electro-optical device according to claim 1, wherein the insulating layer corresponds to the transmissive region of the color filter layer.

3. The electro-optical device according to claim 1, wherein the reflecting films are arranged in the insulating layer in an island shape.

4. The electro-optical device according to claim 1, wherein a scattering layer is provided between the transparent substrate and the reflecting films in at least the region corresponding to the reflecting films.

5. The electro-optical device according to claim 1, wherein the reflecting films comprise island-shaped reflecting films formed in at least one of columns and rows of the pixels.

6. The electro-optical device according to claim 1, wherein the reflecting films comprise island-shaped reflecting films formed at each color pixel that is a set of the respective pixels of R, G, and B color filters.

7. The electro-optical device according to claim 1, wherein the reflecting films comprise island-shaped reflecting films formed in the respective pixels.

8. An electronic apparatus comprising:
a housing; and
a display unit including an electro-optical device;
wherein the electro-optical device includes:
a reflective region and a transmissive region provided in each pixel region;
a plurality of reflecting films constituting the reflective region, the plurality of reflecting films being provided on a transparent substrate so as to correspond to all of the pixel regions;
an insulating layer provided so as to surround each of the reflecting films;
an insulating color filter layer provided in the reflective region and the transmissive region, and further formed on the reflecting films; and
electrodes formed on the color filter layer.

9. A substrate for an electro-optical device, comprising:
a reflective region and a transmissive region provided in each pixel region;
a plurality of reflecting films provided so as to correspond to regions into which an entire pixel region is divided to form the reflective region;
an insulating layer provided so as to surround each of the reflecting films;
an insulating color filter layer provided on the reflecting films; and
electrodes formed on the color filter layer.

10. A method of manufacturing an electro-optical device having a reflective region and a transmissive region formed in each pixel region, the method comprising the steps of:
forming reflecting films which form the reflective region, the plurality of reflecting films being provided on a transparent substrate so as to correspond to the pixel regions;
forming an insulating layer on the transparent substrate so as to surround each of the reflecting films;
forming a color filter layer on the reflecting films; and
forming electrodes on the color filter layer.
